(19) United States
(12) Patent Application Publication
(10) Pub. No.: US 2010/0157608 A1
(43) Pub. Date: Jun. 24, 2010

(54) STRUCTURE OF LIGHT-EMITTING DIODE LIGHTING TUBE

(76) Inventors: Chien-Yuan CHEN, Taipei City (TW); Ying-Te CHUANG, Kaohsiung City (TW); Yi-Sheng CHEN, Taipei City (TW)

Correspondence Address: LEONG C LEI, PMB # 1008, 1867 YGNACIO VALLEY ROAD, WALNUT CREEK, CA, 94598, US

(21) Appl. No.: 12/432,762

(22) Filed: Apr. 30, 2009

(30) Foreign Application Priority Data
Dec. 22, 2008 (TW) 097222951

(51) Int. Cl. F21V 7/00

(52) U.S. Cl. 362/296.01

(57) ABSTRACT

A light-emitting diode lighting tube includes a casing, an aluminum base board, which is fit into the casing and carries a plurality of light-emitting diodes, at least two reflective members respectively arranged on opposite sides of the light-emitting diodes, and first and second end caps respectively mounted to opposite ends of the casing. The casing has a radial cross-section forming an opening extending in an axial direction of the casing. The aluminum base board is fit to retention sections formed beside the opening. The two reflective members are arranged on opposite sides of the LEDs for reflecting lights emitting from the LEDs.

### TECHNICAL FIELD OF THE INVENTION

The present invention generally relates to a structure of a light-emitting diode (LED) lighting tube, and particularly to a lighting tube adopting LEDs as light source.

### DESCRIPTION OF THE PRIOR ART

With the popular application of white LEDs, lighting devices make a remarkable breakthrough in the development thereof. When densely arranged white LEDs are used as a light source of a lighting device, to provide sufficient brightness, the LEDs must be those of high power. This makes heat dissipation a major concern of LED lighting devices.

Secondly, since the light of an LED transmits in a frontward direction and does not form a radial light source, proper concentration of the lights from multiple LEDs is another concern. Further, it is also a challenging issue to arrange a plurality of lined up LEDs without casing shadow of the light sources and to reduce power consumption.

The LED lighting industry is long time troubled by the concerns of heat dissipation and proper concentration of light sources for the LED lighting devices.

Referring to FIG. 9 of the attached drawings, which shows a cross-sectional view of a conventional lighting tube type LED lighting device that comprises a heat dissipation arrangement, a tubular heat dissipation hood (60) that is made of aluminum and has a semi-circular configuration is provided. A plurality of rib-like fins (16) is provided on an outer curved surface of the hood. The outer curved surface forms an outer mounting slot (63) at each lateral edge thereof. The hood (60) also has an inner curved surface that forms an inner retention slot (62) at each lateral edge thereof. The inner retention slots (62) form a rail for receiving a circuit board (70) that carries a plurality of LEDs (71) to fit therein.

In addition, a transparent (acrylic-made) cover (50) opposes the hood (60) and forms retention flanges (51) that extend inward on opposite lateral edges thereof. The retention flanges (51) are fit into the outer mounting slots (63) on the lateral edges of the hood (60) to form a tubular shape fluorescent lamp type LED lighting device.

However, the above described known lighting device has the following disadvantages:

(1) The aluminum made heat dissipation hood (60) and the heat source, which is the LEDs (71), are spaced from each other by a substantial distance, and this makes the heat dissipation performance poor.

(2) The aluminum heat dissipation hood (60) is costly.

(3) The transparent (acrylic made) cover (50) is featureless and the light emitting from the LEDs (71) only travel frontward, making a substantial amount of light randomly projecting in inclined directions rather than being guided to a desired destination zone, whereby the light source is not fully used and waste of energy results. The situation that light is not concentrated on a desired destination also leads to insufficient brightness. Further, shades may occur between the LEDs (71) due to poor brightness caused by light being not concentrated. These are drawbacks of the conventional arrangement.

(4) The circuit board (70) is retained in position by connectors provided on opposite ends. However, for connectors of different sizes, different fitting holes are used. The number of dies/molds used to make these parts must be increased. Further, those connections are susceptible to easy detachment.

### SUMMARY OF THE INVENTION

An objective of the present invention is to provide a light-emitting diode (LED) lighting tube, which simplifies the structure and enhances heat dissipation performance.

Another objective of the present invention is to provide an LED lighting tube that reduces the costs.

A further objective of the present invention is to provide an LED lighting tube that enhances brightness.

To achieve the above objectives, in accordance with the present invention, a structure of an LED lighting tube is provided, comprising a light-transmitting tubular casing, which has a radial cross-section forming an opening extending in an axial direction of the casing and forms retention sections on opposite side walls of the opening; an aluminum base board, which carries a plurality of light-emitting diodes and is fit between the two retention sections; at least two reflective members, which are respectively arranged between the positioning sections and the LEDs for reflecting lights emitting from the LEDs; and first and second end caps, which are respectively mounted to opposite ends of the casing.

In an embodiment, the opening is formed in a top of the casing of the lighting tube. The aluminum base board that caries the LEDs (circuit design) is fit in the opening. Since the aluminum base board provides a function of heat dissipation, it is possible to eliminate the conventionally used semi-circular heat dissipation hood. In this way, costs are cut down and the heat source, such as the LEDs, can dissipate heat into the atmosphere through the aluminum base board, making the heat dissipation performance improved.

In addition, reflective members, such as reflector boards, are arranged in an inclined manner inside the casing of the lighting tube and positioning sections are provided in the casing and respectively opposite to the two retention sections for positioning the two reflective members and making an obtuse angle between the two reflective members. Or alternatively, the reflective members, which are formed as reflector films, are set on an inner wall of the casing. In other words, to be applicable in the present invention, the reflective members only need to be of a construction that reflects lights emitting from the LEDs in such a way to project the lights of the LEDs in a given direction through the reflection in order to concentrate the lights on a fixed zone for enhancement of brightness.

As such, the heat source and the heat dissipation structure are integrated together and spacing therebetween is eliminated, whereby the adverse effect against heat dissipation performance caused by the spacing between the conventional aluminum heat dissipation hood and the heat source can be overcome. In addition, the present invention makes it possible to eliminate the conventionally used aluminum heat dissipation hood, providing comparative economic advantages. Further, the present invention uses reflective members to re-direct the lights to a fixed area and the problem of poor brightness caused by lights being not concentrated in the known devices is overcome. Thus, the present invention is effective in improving heat dissipation for high performance LED lighting tube and reducing costs, and can enhance brightness due to concentration of light and improve the quality of lighting devices.

The foregoing objective and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view, partly exploded, of a lighting tube in accordance with a first embodiment of the present invention.

FIG. 2 is an exploded view of FIG. 1.

FIG. 3 is a radial cross-sectional view of FIG. 1 in an assembled condition.

FIG. 4 is a bottom view of FIG. 1 in an assembled condition.

FIG. 5 is a partial cross-sectional view of FIG. 1 in an assembled condition, showing an axial cross-section of a casing, an aluminum base board, and first and second end caps assembled together.

FIG. 6 is a schematic view showing a lighting tube in accordance with a second embodiment of the present invention.

FIG. 7 is a schematic view showing a lighting tube in accordance with a third embodiment of the present invention.

FIG. 8 is a schematic view showing a lighting tube in accordance with a fourth embodiment of the present invention.

FIG. 9 is a cross-sectional view of a conventional light-emitting diode lighting tube.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

The present invention provides a structure of a light-emitting diode (LED) lighting tube, which comprises a light-transmitting tubular casing (10), an aluminum base board (30) that is inserted into the casing (10) and carries a plurality of LEDs (31), at least two reflective members respectively arranged on opposite sides of the LEDs (31), and first and second end caps (40) respectively mounted to opposite ends of the casing (10).

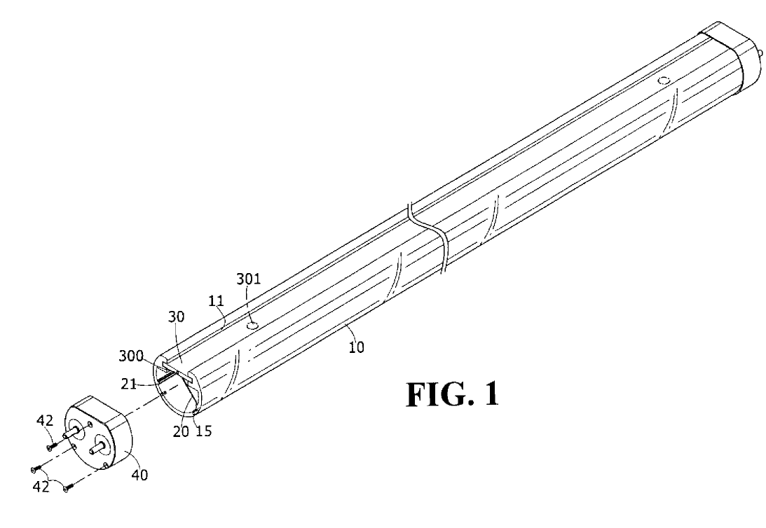

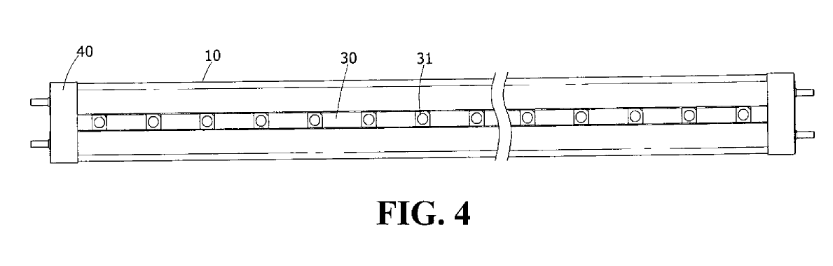

Reference is now made to FIGS. 1-5, which show the LED lighting tube constructed in accordance with a first embodiment of the present invention.

In the instant embodiment, the casing (10) of a suitable length is provided and the casing (10) is a tubular casing made of a light-transmitting material (such as acrylics). It is apparent that the length of the shape of the casing (10) are not limited to these. A plurality of first assembling holes (15) is defined in a tubular wall of the casing (10) at the ends thereof. The casing(10) forms, in a radial cross-section thereof, an opening (11) that extend in an axial direction of the casing (10). Two retention sections (12) are respectively formed on opposite side walls of the opening (11). Two positioning sections (13), (14) are provided to be respectively opposite to the two retention sections (12).

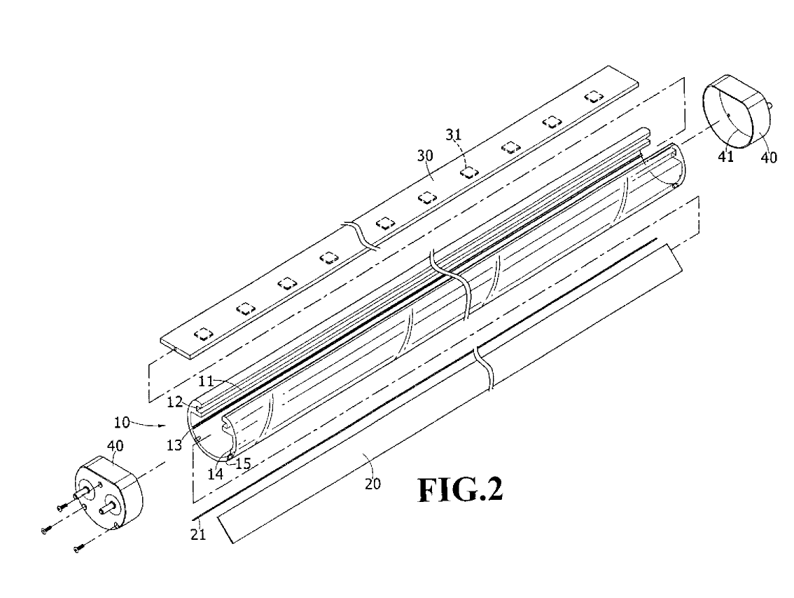

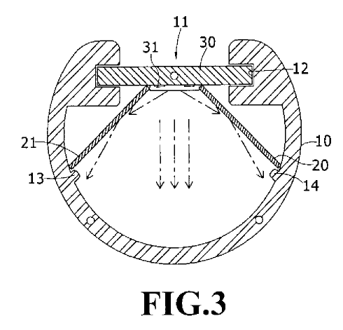

As shown in FIG. 3, the retention sections (12) are formed as two opposing and parallel guide rails of a lying U-shape, such as guide rails having open ends. As shown in FIGS. 2 and 3, the positioning sections (13), (14) of the instant embodiment are formed on an inner surface of the casing (10) in such a way that when viewed in a longitudinal cross-section, the positioning sections (13), (14) are located below one side of the retention sections (12) to form as ribs. The positioning sections (13), (14) extend in the axial direction along the inner wall of the casing (10).

The aluminum base board (30) is provided with a plurality of LEDs (31) that face inward the casing (10). The aluminum base board (30) is fit between the two retention sections (12). The aluminum base board (30) forms second assembling holes (300) in opposite ends thereof. In the instant embodiment, the aluminum base board (30) is formed as for example an elongate board corresponding to length direction of the casing (10) and has a first surface that faces inward the casing (10) and a second surface that is opposite to the first surface and faces outward, wherein the first surface carries the LEDs (31) (as shown in FIGS. 2-4) and the aluminum base board (30) is arranged between the two retention sections (12).

The two reflective members are respectively arranged between the positioning sections (13), (14) and the LEDs (31). In the instant embodiment, the two reflective members are formed as two elongate reflector boards (20), (21), and are arranged to have lower edges of the two reflector boards (20), (21) inclined outwards. However, it other embodiments, the structure of the reflective members can be varied, provided an obtuse angle is formed between the two reflective members to change the traveling paths of lights emitting from the LEDs (31), and it is not necessary to be limited to what described herein.

Also, the two reflector boards (20), (21) are respectively arranged between the two positioning sections (13), (14) and the LEDs (31) and retained inside the casing (10) in such a way to have lower edges of the two reflector boards (20), (21) slightly and outward inclined.

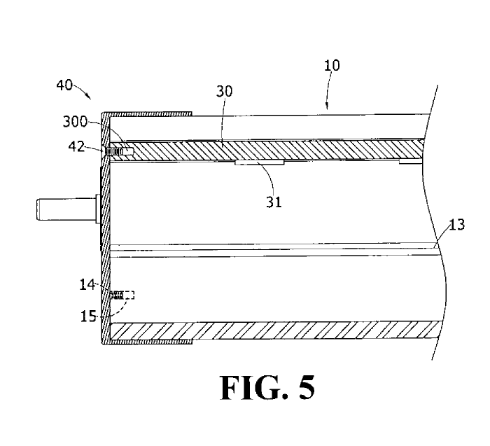

Each of the first and second end caps (40) comprises tip-exposed terminal conductors and forms a recess (41) in an inner side wall thereof and also defines through holes extending therethrough. The recess (41) is fit over a corresponding one of the ends of the casing (10). Referring to FIGS. 1 and 5, a plurality of fasteners (42) extends through the above mentioned through holes and engages the first assembling holes (15) of the casing (10) and the second assembling holes (300) of the aluminum base board (30) in order to securely combine the casing (10), the aluminum base board (30), and the first and second end caps (40) together, making the whole structure integral and tough. It is noted that in the instant embodiment, the first and second end caps (40) are of an identical structure, but it is also feasible to provide end caps of different structures for other embodiments.

The above described arrangement can be expediently applied to lamp tubes of T8 (2.6 cm) and T9 (2.9 cm) specifications, but for the T5 (1.6 cm) specification, modification may be needed in order to keep the LEDs (31) properly distant from an inner bottom surface of the casing (10) so as to prevent causing lighting spots having irregular brightness.

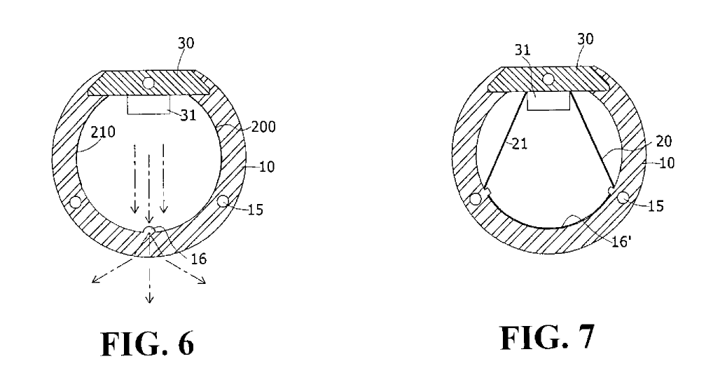

An example is shown in FIG. 6 that illustrates a second embodiment in accordance with the present invention, wherein parts that are similar or identical to those of the previous embodiment bear the same or similar reference and the description thereof is omitted.

The instant embodiment is different from the first embodiment in that the casing (10) is provided with a light diffusion section (16) opposing the LEDs (31), whereby the lights emitting from the LEDs (31) travels through the light diffusion section (16) to be projected outward in a more uniform manner and thereby providing uniform brightness. This improves the inconsistent brightness shown outside a conventional LED lighting tube. In the instant embodiment, the light diffusion section (16) is formed as a raised rib, but it is apparent to those having ordinary skills in the art that the structure of the light diffusion section (16) is not limited to this.

Also, in the instant embodiment, the two reflector boards (20), (21) are replaced with reflector films (200), (210) as shown in FIG. 6, which are directly attached to opposite side walls of the tubular casing (10). In this way, the positioning sections (13), (14) of the first embodiment can be eliminated. Further, the retention sections (12) of the instant embodiment are modified in shape to form a dovetailed guide rail, which provides a force for clamping the aluminum base board (30). In other words, the structure of the retention section (12) is not limited to what described above and can be constructed otherwise, such as an M-shaped rail or other rails of equivalent functions. These are all contemplated by those having ordinary skills in the art.

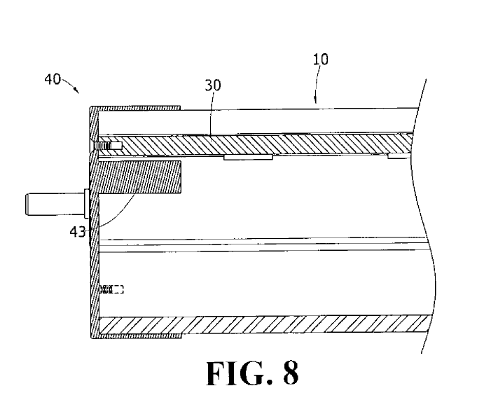

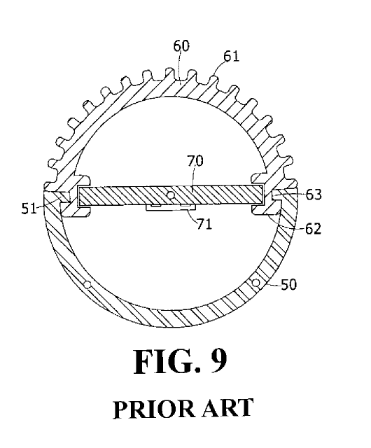

Further, as shown in FIG. 7, a drawing of a third embodiment of the present invention is given. What is different from the second embodiment is that the light diffusion section (16′) is formed as a diffusion film that is attached to an inner wall of the casing (10), and the two reflective members are made the same as the reflector boards (20), (21) of the first embodiment. The light diffusion section (16′) can be a diffusion film attached to an inner wall of the casing (10), or it can be a diffusion film that is integrally formed with the inner wall of the casing (10), provided that it can receive and diffuse the lights emitting from the LEDs (31).

Further, as shown in FIG. 8, a drawing of a fourth embodiment of the present invention is given. What is different from the previous embodiments is that the first and second end caps (40) are both, or any one thereof provided with a support section (43). In the instant embodiment, the support section (43) is formed on an inner side of the first or second end cap (40) and extends inward into the casing (10) so as to form, such as a rectangular platform. Although the support sections (43) are provided in both the first and second end caps (40) in the instant embodiment, yet it is feasible to provide only one support section (43) in either the first or second end cap (40). Further, the size and shape of the support section (43) are not limited to what described above. For example, two support sections (43) can be sized to have a total length thereof substantially corresponding to the aluminum base board (30) so to as provide a complete support to the aluminum base board (30).

The present invention can be modified in various ways. For example, mounting pieces (not shown) can be arranged on the back surface of the aluminum base board (30). For example, as shown in FIG. 1, a mounting piece can be made as a hook or forming a locking hole at a position (301) for direct coupling with the casing (10) in order to make the whole structure more stable and firm.

Compared to the known devices, the present invention offers the following advantages, but not limited thereto:

(1) The present invention does not need the conventionally used semi-tubular metal made heat dissipation hood, so that the cost is relatively low.

(2) The present invention provide an aluminum base board that is exposed on the top of the lighting tube, offering capability of direct heat dissipation, so that heat dissipation performance is improved.

(3) The present invention provides a lighting tube containing therein reflector boards, which concentrates the lights that travel in random directions, so as to improve the brightness.

(4) The present invention provides an aluminum base board that can be provided, on the back surface thereof, with fastening mechanisms, such as a hook or a locking hole, for direct coupling with the casing through use of a hooking member or tightening of a chain, whereby when the end caps of the casing get loosened or detached, the structure can still maintain stable and firm, making it safer as a whole.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A light-emitting diode lighting tube, comprising:
a light-transmitting tubular casing, which has a radial cross-section forming an opening extending in an axial direction of the casing and forms retention sections on opposite side walls of the opening;
an aluminum base board, which carries a plurality of light-emitting diodes and is fit between the two retention sections;
at least two reflective members, which are respectively arranged on opposite sides of the light-emitting diodes to reflect lights emitting from the light-emitting diodes, an obtuse angle being formed between the two reflective members; and
first and second end caps, which are respectively mounted to opposite ends of the casing.

2. The light-emitting diode lighting tube according to claim 1, wherein the retention sections form opposite guide rails.

3. The light-emitting diode lighting tube according to claim 1, wherein the reflective members each selectively comprise a reflector board or a reflector film.

4. The light-emitting diode lighting tube according to claim 3, wherein the reflective members comprise reflector boards and wherein the casing comprises positioning sections provided respectively opposite to the two retention sections for positioning the reflective members.

5. The light-emitting diode lighting tube according to claim 4, wherein the positioning sections each selectively comprise a rib or a ditch.

6. The light-emitting diode lighting tube according to claim 3, wherein the reflective members comprise reflector films.

7. The light-emitting diode lighting tube according to claim 6, wherein the reflective members are set on an inner wall of the casing.

8. The light-emitting diode lighting tube according to claim 1, wherein the casing comprises a light diffusion section.

9. The light-emitting diode lighting tube according to claim 8, wherein the light diffusion section comprises a raised rib or a light diffusion film.

10. The light-emitting diode lighting tube according to claim 1, wherein the first and second end caps each comprise two tip-exposed terminal conductors and form an inner recess and also define holes extending therethrough.

11. The light-emitting diode lighting tube according to claim 1, wherein the first and second end caps comprises a support section formed on an inner side thereof and extending inward into the casing.

12. The light-emitting diode lighting tube according to claim 11, wherein the support section comprises a rectangular platform.
